(19) United States
(12) Patent Application Publication
(10) Pub. No.: US 2019/0283546 A1
(43) Pub. Date: Sep. 19, 2019

(54) Method For Enriching Air With At Least One Aromatic Substance

(71) Applicant: Hans-Peter Schlegelmilch, Mönchengladbach (DE)

(72) Inventor: Hans-Peter Schlegelmilch, Mönchengladbach (DE)

(21) Appl. No.: 16/463,640

(22) PCT Filed: Nov. 30, 2017
(86) PCT No.: PCT/EP2017/001395

§ 371 Date: May 23, 2019

(30) Foreign Application Priority Data
Dec. 1, 2016 (DE) 20 2016 007 340.1

(51) Int. Cl. B60H 3/00; B60H 1/00

(52) U.S. Cl. CPC B60H 3/0035; B60H 1/00742

(57) ABSTRACT

The invention relates to a method for enriching air with at least one aromatic substance, which is in particular dissolved in a carrier medium. Here, the aromatic substance is actively released in a predefined quantity into the air, which is for example situated in an interior compartment or which is intended to be fed in flowing form to said interior compartment. According to the invention, it is proposed that the dispensing of the at least one aromatic substance into the air is performed in a dynamically closed-loop-controlled manner. Accordingly, the at least one aromatic substance is released in reaction to a detectable state of a person exposed to the air and/or in accordance with a simulation.

### FIELD OF THE INVENTION

### Background

The invention relates to a method for enriching air with at least one aromatic substance according to the features in the preamble of claim 1.

### Technical Background

Perception is based on external stimuli, the detection of which by one or more sensory organ(s) gives a person an idea of his/her surrounding environment. In particular, visual impressions are the most important, since of the five basic senses the sense of sight has the greatest reception capacity. Sight is indeed based on only minor cognitive control, however olfactory stimuli in particular can trigger a direct decision-making process. In fact, odours perceived by the sense of smell lead to an immediate reaction, almost without any participation of one's consciousness.

Considered on a somatic level, this is due to the close connection between the sense of smell and the limbic system, which is a known centre for memory and emotions. From an evolutionary viewpoint, this relationship for example with the decision-making capability, which is near vital, can answer the question of whether a food brought just in front of the oral cavity is still edible or not. Further stimuli indicating danger, such as the smell of fire, are further examples in this regard. On the whole, the power of the sense of smell extends as far as a person's choice in partner, wherein, amongst other things, a subconscious comparison with regard to a possible match between the genes potentially mixing with one another is assumed.

In conjunction with the sense of smell in humans, it is known that for example the mood of individuals can change as a result of an olfactory stimulus being taken in via the nose. Direct bodily reactions can sometimes also be triggered by breathing in certain fragrances, which for example lead to a feeling of nausea or hunger. Fragrances that can be used for this purpose are based on their purely natural formation, whereas aromatic substances generally occur in a natural form and also can be generated artificially.

Based on this finding, aromatic substances are used consciously in many ways. The fields of application extend from targeted therapy forms to attempts to influence human shopping habits (functional fragrancing). The actual release of the aromatic substance in question or of a combination of a plurality of aromatic substances can be achieved in many ways. Since aromatic substances are transported to a receiver via the air or breathing air, they need to be evaporated or atomised accordingly. Known methods utilise a usually continuous release of aromatic substances, for example via a wick or a vaporisation via the surface of a volume of aromatic substance in contact with air.

Document DE 100 27 428 A1 in this regard discloses an apparatus based on air technology which is used to expose air to vapours or aerosols of fragrance-carrying substances. The core concept there is the use of at least one electrically controllable micropump, which is connected via a pipeline to an odour-tight container. The “inkjet” principle known from inkjet printers, which utilises precisely dosing and economical micropumps, can be used here. In this way a fragrance-carrying substance situated in the container can be dispensed in a predefined amount, either by being sprayed directly into an airflow or firstly onto a carrier, from where the liquefying substance is then delivered to the airflow. In this regard a freely programmable electronic controller is provided, by which the fragrances can be modified in respect of their delivery over time, their desired intensity, and the particular type or mixture.

With the known apparatus based on air technology, it is possible to enrich in particular flowing air with at least one aromatic substance. Due to the use of at least one electrically controllable micropump, the aromatic substance dissolved in a carrier liquid can be actively dispensed, such that a defined amount of aromatic substance can be released selectively. The released amount of aromatic substance in alternative methods, by contrast, can be determined only vaguely—if at all—since said methods are based on a comparatively uncontrolled release of aromatic substance. No measures that go beyond the fixing of a time and the intensity and type of aromatic substance and also the combination of said aromatic substance with other aromatic substances are known, and therefore in particular the versatility for use of apparatuses of this kind also offers further scope for improvement.

### SUMMARY OF THE INVENTION

On this basis the object of the present invention is to further develop a method for enriching air with at least one aromatic substance such that the associated possibility of supporting any known effects on a person exposed to the air enriched in this way can be achieved in a more versatile manner and in a manner more suitable for the situation in question.

The solution to this problem, in accordance with the invention, lies in a method for enriching air with at least one aromatic substance according to the features of claim 1. Further details, features and advantages of the subjects of the invention will become clear from the dependent claims.

To this end, it is proposed by the invention that the dispensing of the at least one aromatic substance is performed in a dynamically closed-loop-controlled manner, this method offering more versatile possibilities going beyond a purely time-based and amount- or type-based release of aromatic substance(s) as previously defined. In this way it is now possible to release the at least one aromatic substance selectively, for example in reaction to a detectable current state of a person who can be exposed or is exposed to the air that can be enriched or is enriched in this way.

Alternatively or additionally hereto, it is also possible to release the at least aromatic substance in close coordination with an actual or simulated event attended by the person in question. The content of a simulation presented to the person can thus also be supported. Said support can be provided particularly preferably in real time, such that for example content received via the sense of sight and/or the sense of hearing can be combined with olfactory stimuli coordinated selectively therewith.

The resultant advantage can be considered to be the possibility of an interaction so to speak, whereupon the at least one aromatic substance can now be released selectively on account of actual events or states and also simulated incidents. In this way a selective reflex effect in accordance with the particular actual and/or simulated situation can be triggered in the person in question, preferably in the form of a closed control loop so to speak, so as to thus attain a behaviour satisfying the current requirements and/or adapted thereto. The support of any known effects by the deliberate use of selected aromatic substances can thus be provided in extremely more versatile form, fulfilling the situation in question to a large extent.

Within the scope of the invention it should be defined that a closed-loop control for the amount of aromatic substance to be released is provided in such a way that the concentration of said aromatic substance in room air and/or an air flow is preferably held below an average threshold value for the human ability to smell, so as to form a deliberate olfactory impression. In other words, a sensory impression or a sensory impression that is deliberately too strong or provided beyond the olfactory impression should be prevented from being provided. Particularly, excessive concentration can result in quite opposite effects or can be found to be at least inappropriate or unpleasant. A dosing of the at least one aromatic substance below the typical perception threshold should be given preference in this regard. An exception could be provided for example by moments at which the person exposed to the air to be enriched must be brought quite deliberately out of a state that could become dangerous.

The aromatic substance to be used can be present particularly advantageously in a form that allows the quickest possible release thereof. To this end a carrier medium can be used in which the aromatic substance in question is dissolved. The carrier medium can be, for example, a liquid, such as water or alcohol. In this way the aromatic substance can be released by evaporating and/or spraying or atomising in air the carrier medium with the aromatic substance dissolved therein. Alternatively, a gas as carrier medium would also be conceivable, which gas would then be released to the air in a comparable way. The use of the aromatic substance without dissolving it within a carrier medium would also be conceivable. To this end the aromatic substance can be present for example in a very fine powder form, which allows it to be finely atomised in air.

In principle the aromatic substance in question should be stored in a suitable container, from which it can then be removed selectively. The container should advantageously have odour-proof properties, such that the aromatic substance actually only passes into the air if this is also desired. Particularly, in a form dissolved within a carrier medium, the aromatic substance can thus be stored as liquid or in gas form in the container in question. The use of containers additionally enables a simple exchange thereof and/or simple refilling thereof.

In accordance with a development of the inventive concept in question the method according to the invention can be applied preferably within a space. This space for example may be a stationary space, for example within a building, or by contrast a mobile space, such as the interior of a vehicle. By way of example, vehicles in the form of aircraft, land vehicles or watercraft are possible for the last-mentioned potential use, which vehicles for example include aeroplanes, motor vehicles or boats/ships, to name just a few.

In this context the at least one aromatic substance can be released into the air already provided in the interior of a vehicle. Alternatively or additionally, the at least one aromatic substance can be released into flowing air or an airflow which is then fed to the interior of a vehicle. On account of the (in this case) known volume of the interior, an extremely precise dosing for the at least one aromatic substance can be ensured, in order to attain the particular effect and/or the particular impact for a person exposed to the air enriched in this way in the interior of the vehicle.

The aromatic substance can be released particularly preferably based on an analysis of control behaviour of the person operating the vehicle. The person controlling the vehicle may advantageously be a person who is operating the vehicle from its interior. Of course, it is also conceivable that the person operating the vehicle is not situated in the interior of the vehicle, as is the case for example with a remote-controlled vehicle. In such a case it is possible to enrich the air in the space in question in the previously described way, independently of where this space is located.

Alternatively or additionally to an analysis of the current control behaviour of a person operating a vehicle, the particular stress level of said person can also be referenced and analysed so as to thereupon perform a selective enrichment of the air that can be received by the person.

The invention thus proposes, in the contexts described above, that for example the control behaviour of the person situated in particular in the interior of the vehicle is detected and analysed by at least one vehicle assistance system by sensor. To this end, assistance systems already established in a vehicle, which already monitor the driving and/or control behaviour of the person for other reasons, can be used advantageously. Possible assistance systems are for example those that are designed to detect a reduction in the attention of the person operating the vehicle (attention assist) and/or carelessness of said person. Specifically, these include, amongst other things, lane-keeping assistants and brake actuation assistants, on the basis of which an active intervention in the operation of the vehicle can also be implemented from time to time.

In this way, assistance systems of the vehicle that are already provided can be used advantageously, for example in order to create the possibility, going beyond acoustic and/or optical signals, to react to or even influence any actions or failures of the person operating the vehicle by way of olfactory stimuli.

A further proposal of the invention that takes into account the contexts described above is directed to the fact that the stress level of the person in question can be analysed on the basis of at least one vital function of the person detectable by sensor. For example, rising values for blood pressure and/or pulse rate may indicate an increased state of excitement of the person, on which basis the current stress level of said person can be concluded. Similarly, bodily reactions for example in the form of perspiration and/or increasing agitation signalled by an increased urge to move could be used to determine the stress level of the person.

Regardless of the way in which the state of the person monitored in this way by sensor is determined, it is considered particularly advantageous within the scope of the invention if, for example, at least one aromatic substance exciting the person is released in the event that a state indicating overtiredness is detected. Particularly in the case of a person operating a vehicle, it would thus be made possible to revitalise the person in such a manner that they remain unconscious of it. The objective here would be to increase the attention level of the person to such an extent that for example they can continue driving safely. Alternatively or additionally, an aromatic substance warning the person could also be released, in order to restore their attention practically immediately. A major intervention of this kind would be conceivable in cases in which the current state of the person represents a potential acute safety risk, for example if the person is at risk of falling asleep, or indeed has already fallen asleep, whilst driving.

In accordance with a further development of the inventive concept, it is also conceivable in this regard to identify a state of the person that for example goes beyond a previously defined level of excitation and to influence this state in such a way that a potentially dangerous behaviour is changed or at least reduced in respect of its development. For example, dangerous behaviour could be considered to be behaviour in which a potentially uncontrolled overreaction is imminent and/or an excessively high level of risk-taking among the road traffic is present. In this regard the invention provides that, in the event of a state of the person indicating a degree of excitation, at least one aromatic substance calming and/or pacifying this person could be released into the air. The objective is to achieve a reflex effect in the form of a reduction of the current stress level of the person in question, as to attain a continual adapted behaviour.

A further field of use of the method according to the invention offers simulations in respect of virtual reality (VR). This means the computer-generated simulation of a usually interactive virtual environment which is displayed to a person for example via visually and/or acoustically perceptible stimuli. For example, situations and physical properties thereof can be displayed in this simulation in real time and are perceived by the person in question as potential reality. Of course, real parts, such as the visual perception of the actual environment, can be supplemented with purely simulated content.

Here, the at least one aromatic substance could be released in accordance with a simulation focussed on the generation and/or supplementation of virtual reality. It would be possible to selectively support the content of the simulation, shown to a person for example by means of 3D glasses, by olfactory stimuli. As a result, the feeling of “reality” of the virtual reality can thus be improved further. Possible fields of application extend here from simulations used for training purposes (for example pilot training) to private households, where for example a computer-generated gaming experience can be supported accordingly.

The enrichment, necessary for the method according to the invention, of the air received by the person, particularly via the nose, can be performed in various ways. Besides the dispensing of the at least one aromatic substance to the air surrounding a person (ambient air, particularly in a closed space), it is considered advantageous—depending on the particular field of use of the invention—if the aromatic substance is released into flowing air. This can be achieved for example via a ventilation system arranged in a building and/or a vehicle. Alternatively or additionally the invention provides the use of a fluid-guiding system, which makes it possible to feed the at least one aromatic substance to the person in question via a respiratory tube and/or a respiratory mask arranged thereon. This results in fields of use going beyond those already discussed, such that for example individuals suffering from anxiety could also be supported advantageously during a necessary treatment as a result of having their individual stress level maintained within a range tolerable or even comfortable for the person in question.

Two or more different aromatic substances could particularly preferably also be released into the air (for example still or flowing air) at the same time or at different times. This enables an advantageous composition of individual aromatic substances as to thus attain a greater possible spectrum of reflex effects in the person in question on the basis of a few different aromatic substances. Thus, two or more aromatic substances either can attain a different effect as compared to the individual aromatic substances, or two or more effects can be triggered in succession or at the same time. To this end the invention proposes an either simultaneous, parallel release of the aromatic substances or a prior mixing thereof, before they are used in the form of a composition to enrich the air.

Within the scope of the invention, it is considered to be extremely advantageous if, in order to attain a reproducible and guaranteed effect, the air to be enriched with one or more aromatic substances is firstly neutralised in respect of the aromatic substances or an aromatic substance already contained therein. The at least one aromatic substance can then be actively released into the air neutralised beforehand. Possible embodiments for this could include one or more corresponding filters. The selective use of energy could allow a selective ionisation of the air, so as to support the neutralisation thereof by oxidation of the undesirable odour molecules and/or enrichment with the one or more desired aromatic substance(s). Any substances binding aromatic substances or fragrances or odours are also conceivable, such as the use of titanium dioxide (TiO₂). Chemical aerosols, for example odour molecules perceived to be unpleasant, can be isolated or destroyed within the scope of a prior air neutralisation. It is hereby possible to reliably anticipate potential interactions caused by an undesirable mixing of actively released aromatic substance(s).

1. A method for enriching air with at least one aromatic substance, which is in particular dissolved in a carrier medium, in which method the aromatic substance is actively released in a predefined quantity into the air, characterized in that the release of the at least one aromatic substance is performed in a dynamically closed-loop-controlled manner, wherein the at least one aromatic substance is released in reaction to a detectable state of a person exposed to the air and/or in accordance with a simulation.

2. The method according to claim 1, characterized in that the at least one aromatic substance is released into the air present in the interior of a vehicle and/or into the air that can be fed to an interior of a vehicle, wherein the release of the aromatic substance is performed on the basis of an analysis of a control behaviour and/or a stress level of the person operating the vehicle from the interior thereof.

3. The method according to claim 2, characterized in that the control behaviour of the person is detected and analyzed by at least one vehicle assistance system by sensor.

4. The method according to claim 2, characterized in that the stress level of the person is analyzed on the basis of at least one vital function of the person detectable by sensor.

5. The method according to claim 1, characterized in that in the event that a state of the person indicating overtiredness is detected, at least one aromatic substance stimulating and/or warning the person is released into the air.

6. The method according to claim 1, characterized in that in the event that a state of the person indicating a degree of excitement is detected, at least one aromatic substance calming and/or pacifying the person is released into the air.

7. The method according to claim 1, characterized in that the at least one aromatic substance is released in accordance with a simulation oriented towards the generation of and/or supplementation by virtual reality.

8. The method according to claim 1, characterized in that the at least one aromatic substance is released into flowing air which can be supplied to the person via a fluid-guiding system, in particular via respiratory tube and/or a respiratory mask arranged thereon.

9. The method according to claim 1, characterized in that two or more aromatic substances are released into the air, wherein the aromatic substances are mixed with one another prior to their release or are released in parallel with one another.

10. The method according to claim 1, characterized in that the air is neutralized in respect of at least one aromatic substance already present therein, before the at least one aromatic substance is actively released into the air thus neutralized.
